(19) United States
(12) Patent Application Publication
(10) Pub. No.: US 2013/0342736 A1
(43) Pub. Date: Dec. 26, 2013

(54) IMAGE PROCESSING APPARATUS, IMAGING APPARATUS, IMAGE PROCESSING METHOD, AND PROGRAM

(71) Applicant: SONY CORPORATION, Tokyo (JP)

(72) Inventor: Satoshi NUMATA, Tokyo (JP)

(73) Assignee: SONY CORPORATION, Tokyo (JP)

(21) Appl. No.: 13/867,224

(22) Filed: Apr. 22, 2013

(30) Foreign Application Priority Data
Jun. 20, 2012 (JP) 2012-138511

(51) Int. Cl. G06T 5/00

(52) U.S. Cl. CPC G06T 5/002
USPC 348/241; 382/266

(57) ABSTRACT

An image processing apparatus includes: a noise-removed image generation unit which, on the basis of an input image and a reduced image obtained by reducing the input image at predetermined magnification, generates a noise-removed image with noise in the input image removed; and a corrected image generation unit which generates, from the noise-removed image, a high-frequency component image primarily having a frequency component of the noise-removed image in the same band as a frequency component to be removed by band limitation in the reduction at the predetermined magnification and generates an edge-corrected image on the basis of the noise-removed image and the high-frequency component image.

### FIELD

The present technology relates to an image processing apparatus. Specifically, the present technology relates to an image processing apparatus, an imaging apparatus, and an image processing method which correct noise, and a program which causes a computer to execute the method.

### BACKGROUND

In recent years, an imaging apparatus, such as a digital still camera or a digital video camera (for example, a recorder with a camera), which captures a subject, such as a person, to generate a captured image and records the generated captured image has come into wide use. The image captured by the digital imaging apparatus generally includes noise.

Noise of the captured image includes noise (high-frequency noise) which appears randomly in a small number of pixels and can be removed by a filter with a small number of taps, and noise (low-frequency noise) which appears in a wide range of pixels and can be removed only by a filter with a large number of taps.

Low-frequency noise can be removed by processing in a filter with a large number of taps. However, processing by a filter with a large number of taps is heavy. For this reason, a method of simply removing low-frequency noise has been suggested. For example, an image processing method which removes low-frequency noise on the basis of an input image and a reduced image of the input image has been suggested (for example, see JP-A-2004-295361).

In this image processing method, an average value in a predetermined range is compared with a pixel value in the input image to separate noise from a significant signal, and a pixel value with a lot of noise is replaced with replaced data generated from the reduced image, thereby removing low-frequency noise in the input image.

### SUMMARY

In the related art, replaced data is generated from the reduced image, whereby low-frequency noise in the input image can be removed. However, since replaced data generated from the reduced image is an image having less high-frequency components and low resolution, when replacement is done at an edge or a near edge, resolution may be lowered. Accordingly, it is important to remove noise such that resolution in an image is not damaged.

It is therefore desirable to improve image quality in an image subjected to noise removal processing.

An embodiment of the present technology is directed to an image processing apparatus including a noise-removed image generation unit which, on the basis of an input image and a reduced image obtained by reducing the input image at predetermined magnification, generates a noise-removed image with noise in the input image removed, and a corrected image generation unit which generates, from the noise-removed image, a high-frequency component image primarily having a frequency component of the noise-removed image in the same band as a frequency component to be removed by band limitation in the reduction at the predetermined magnification and generates an edge-corrected image on the basis of the noise-removed image and the high-frequency component image, an image processing method, and a program. With this configuration, edge correction is performed on the noise-removed image generated on the basis of the input image and the reduced image using the frequency component of the noise-removed image in the same band as the frequency component to be removed by the band limitation when generating the reduced image.

In the of the present technology, the corrected image generation unit may generate the high-frequency component image by subtraction processing for each pixel between a low-frequency component image primarily having a frequency component to be not removed by the band limitation and the noise-removed image. With this configuration, the high-frequency component image is generated by the subtraction processing for each pixel between the low-frequency component image primarily having the frequency component to be not removed by the band limitation and the noise-removed image.

In the embodiment of the present technology, the noise-removed image generation unit may generate a second noise-removed image by enlarging an image with noise in the reduced image removed at the predetermined magnification and may then generate the noise-removed image by addition processing for each pixel between the second noise-removed image and the input image in accordance with an addition ratio set for each pixel, and the corrected image generation unit may generate the high-frequency component image using the second noise-removed image as the low-frequency component image. With this configuration, the high-frequency component image is generated using the second noise-removed image obtained by enlarging the image with noise in the reduced image removed at the predetermined magnification.

In the embodiment of the present technology, the corrected image generation unit may generate the high-frequency component image using an image obtained by reducing and then enlarging the noise-removed image at the predetermined magnification as the low-frequency component image. With this configuration, the high-frequency component image is generated using the image obtained by reducing and then enlarging the noise-removed image at the predetermined magnification.

In the embodiment of the present technology, the corrected image generation unit may generate the high-frequency component image using an image obtained by reducing and then enlarging the reduced image at the predetermined magnification as the low-frequency component image. With this configuration, the high-frequency component image is generated using the image obtained by reducing and then enlarging the reduced image at the predetermined magnification.

In the embodiment of the present technology, the corrected image generation unit may generate the edge-corrected image by unsharp mask processing on the basis of the noise-removed image and the high-frequency component image. With this configuration, edge correction is performed by the unsharp mask processing.

Another embodiment of the present technology is directed to an image processing apparatus including a reduced image generation unit which generates a reduced image by reducing an input image at predetermined magnification, a noise-removed image generation unit which generates a noise-removed image with noise in the input image removed on the basis of the input image and the reduced image when edge enhancement is performed on the input image, and a corrected image generation unit which generates a high-frequency component image on the basis of the generated reduced image and the noise-removed image when the edge enhancement is performed and generates an edge-corrected image by unsharp mask processing on the basis of the noise-removed image and the high-frequency component image. With this configuration, when edge enhancement is performed, edge correction is performed on the noise-removed image generated on the basis of the input image and the reduced image using the frequency component of the noise-removed image in the same band as the frequency component to be removed by the band limitation when generating the reduced image.

In the another embodiment of the present technology, the corrected image generation unit may generate a second high-frequency component image on the basis of the reduced image and the input image when contrast enhancement is performed on the input image and may generate a contrast-enhanced image by the unsharp mask processing on the basis of the input image and the second high-frequency component image, and the noise-removed image generation unit may generate an image with noise in the contrast-enhanced image removed on the basis of the reduced image and the contrast-enhanced image when the contrast enhancement is performed. With this configuration, when contrast enhancement is performed, noise removal using the reduced image is performed after contrast enhancement is performed by the unsharp mask processing.

Still another embodiment of the present technology is directed to an imaging apparatus including a lens unit which condenses subject light, an imaging device which converts subject light to an electrical signal, a signal processing unit which converts the electrical signal output from the imaging device to a predetermined input image, a noise-removed image generation unit which, on the basis of the an input image and a reduced image obtained by reducing the input image at predetermined magnification, generates a noise-removed image with noise in the input image removed, a corrected image generation unit which generates, from the noise-removed image, a high-frequency component image primarily having a frequency component of the noise-removed image in the same band as a frequency component to be removed by band limitation in the reduction at the predetermined magnification and generates an edge-corrected image on the basis of the noise-removed image and the high-frequency component image, and a recording processing unit which compresses and encodes the generated edge-corrected image to generate and record recording data. With this configuration, edge correction is performed on the noise-removed image generated on the basis of the input image and the reduced image using the frequency component of the noise-removed image in the same band as the frequency component to be removed by band limitation when generating the reduced image, and the image subjected to the edge correction is recorded.

The embodiments of the present technology have a beneficial effect of improving image quality in an image subjected to noise removal processing.

### BRIEF DESCRIPTION OF THE DRAWINGS

FIG. 1 is a block diagram showing an example of the functional configuration of an imaging apparatus according to a first embodiment of the present technology;

FIG. 2 is a block diagram schematically showing a functional configuration example of an NR unit according to the first embodiment of the present technology;

FIGS. 3A and 3B are diagrams illustrating an edge, a near edge, and a flat portion which are used when illustrating image processing in the NR unit according to the first embodiment of the present technology;

FIGS. 4A to 4G are diagrams schematically showing transition of a pixel value during reduction NR processing and unsharp mask processing by the NR unit according to the first embodiment of the present technology.

FIGS. 5A to 5D are diagrams schematically showing the relationship between a frequency component of an image and image processing so as to illustrate image processing in the NR unit according to the first embodiment of the present technology.

FIGS. 6A to 6C are diagrams schematically showing the relationship between a frequency component of a difference image and a frequency component of an image after reduction NR used for unsharp mask processing in the NR unit according to the first embodiment of the present technology.

FIGS. 7A and 7B are diagrams schematically showing the details of unsharp mask processing in the NR unit according to the first embodiment of the present technology.

FIGS. 8A to 8D are diagrams illustrating the effects using similar band limitation during reduction NR processing and unsharp mask processing in the NR unit according to the first embodiment of the present technology.

FIG. 9 is a flowchart showing a processing procedure example when image processing is performed by the NR unit according to the first embodiment of the present technology.

FIG. 10 is a block diagram showing an example of the functional configuration of an NR unit according to a second embodiment of the present technology.

FIG. 11 is a flowchart showing a processing procedure example when image processing is performed by the NR unit according to the second embodiment of the present technology.

FIG. 12 is a block diagram showing an example of the functional configuration of an NR unit, which calculates a difference using an image obtained by reducing an image after reduction NR, as a modification of the first embodiment of the present technology.

FIG. 13 is a block diagram showing an example of the functional configuration of an NR unit, which performs reduction NR processing and near-edge enhancement using reduced image generated by an image reduction unit, as a modification of the first embodiment of the present technology.

### DESCRIPTION OF PREFERRED EMBODIMENTS

Hereinafter, a mode (hereinafter, referred to as an embodiment) for carrying out the present technology will be described. The description will be provided in the following sequence.

1. First Embodiment (image processing control: an example where reduction NR processing and unsharp mask processing are performed using the same reduction ratio)

2. Second Embodiment (image processing control: an example where contrast enhancement of an entire image and reduction NR processing are performed)

3. Modification

### 1. First Embodiment

### Functional Configuration Example of Imaging Apparatus

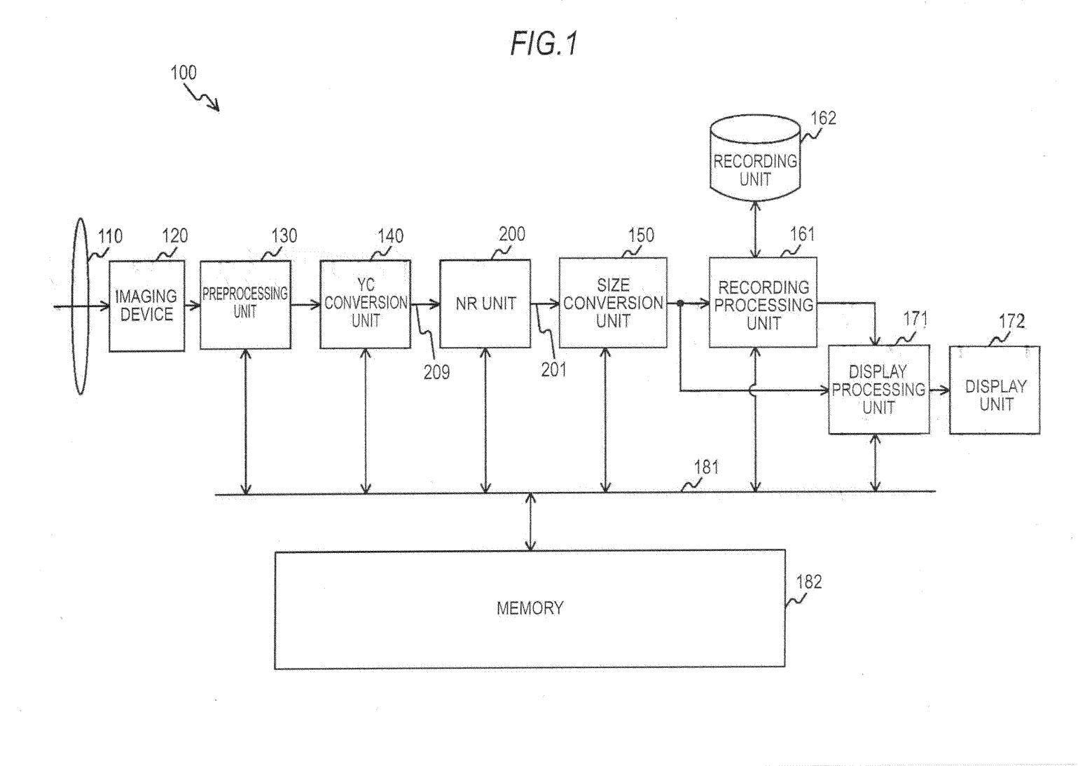

FIG. 1 is a block diagram showing an example of the functional configuration of an imaging apparatus 100 according to a first embodiment of the present technology.

The imaging apparatus 100 is an imaging apparatus (for example, a compact digital camera) which captures a subject to generate image data (captured image) and records the generated image data as an image content (still image content or motion image content).

The imaging apparatus 100 includes a lens unit 110, an imaging device 120, a preprocessing unit 130, an YC conversion unit 140, an NR (Noise Reduction) unit 200, and a size conversion unit 150. The imaging apparatus 100 includes a recording processing unit 161, a recording unit 162, a display processing unit 171, a display unit 172, a bus 181, and a memory 182.

The bus 181 is a bus for data transfer in the imaging apparatus 100. For example, when image processing is performed, data which should be temporarily stored is stored in the memory 182 through the bus 181.

The memory 182 temporarily stores data in the imaging apparatus 100. The memory 182 is used as, for example, a work area of each kind of signal processing in the imaging apparatus 100. The memory 182 is realized by, for example, a DRAM (Dynamic Random Access Memory).

The lens unit 110 condenses light (subject light) from the subject. In FIG. 1, respective members (various lenses, such as a focus lens and a zoom lens, an optical filter, an aperture stop, and the like) arranged in an imaging optical system are collectively referred to as the lens unit 110. Subject light condensed by the lens unit 110 is imaged on an exposed surface of the imaging device 120.

The imaging device 120 photoelectrically converts subject light to an electrical signal, and receives subject light and generates an electrical signal. The imaging device 120 is realized by, for example, a solid-state imaging device, such as a CMOS (Complementary Metal Oxide Semiconductor) sensor or a CCD (Charge Coupled Device) sensor. The imaging device 120 supplies the generated electrical signal to the preprocessing unit 130 as an image signal (RAW signal).

The preprocessing unit 130 performs various kinds of signal processing on the image signal (RAW signal) supplied from the imaging device 120. For example, the preprocessing unit 130 performs image signal processing, such as noise removal, white balance adjustment, color correction, edge enhancement, gamma correction, and resolution conversion. The preprocessing unit 130 supplies the image signal subjected to various kinds of signal processing to the YC conversion unit 140.

The YC conversion unit 140 converts the image signal supplied from the preprocessing unit 130 to an YC signal. The YC signal is an image signal including a luminance component (Y) and a red/blue color-difference component (Cr/Cb). The YC conversion unit 140 supplies the generated YC signal to the NR unit 200 through a signal line 209. The YC conversion unit 140 and the preprocessing unit 130 are an example of a signal processing unit described in the appended claims.

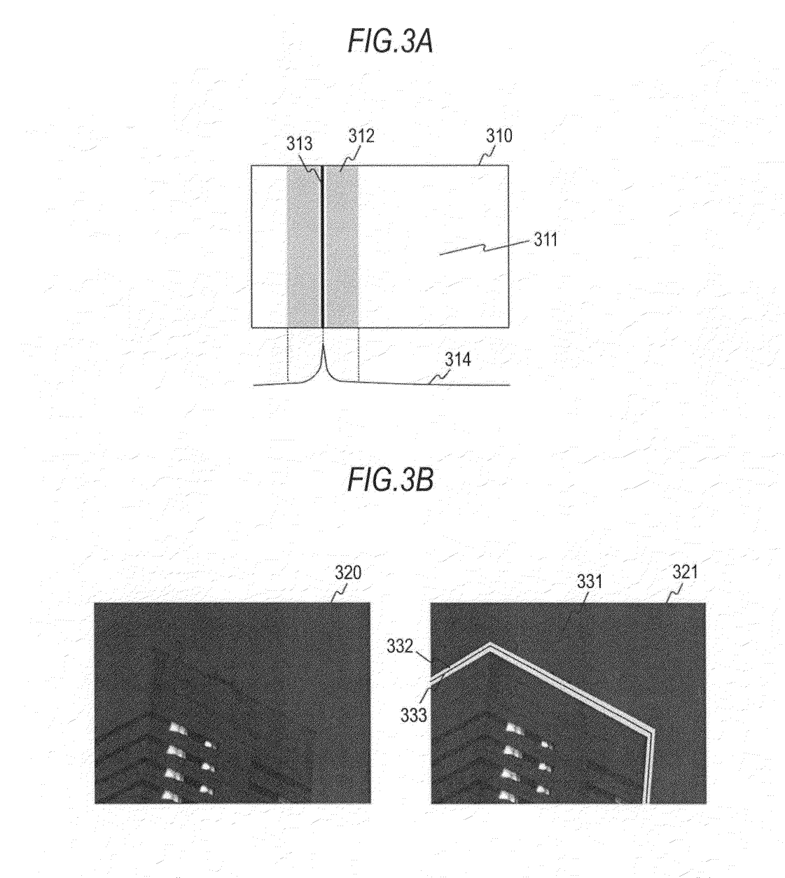

The NR unit 200 removes noise included in the image supplied from the YC conversion unit 140 as the YC signal. The NR unit 200 performs noise removal processing using a reduced image and also performs unsharp mask processing for restoring resolution which is lowered during the noise removal processing. Accordingly, the NR unit 200 generates an image in which low-frequency noise is reduced and resolution is satisfactory at an edge and a near edge. In the first embodiment of the present technology, for convenience of description, description will be provided dividing an image into an edge, a near edge, and a flat portion. An edge, a near edge, and a flat portion will be described referring to FIGS. 3A and 3B, thus description herein will be omitted.

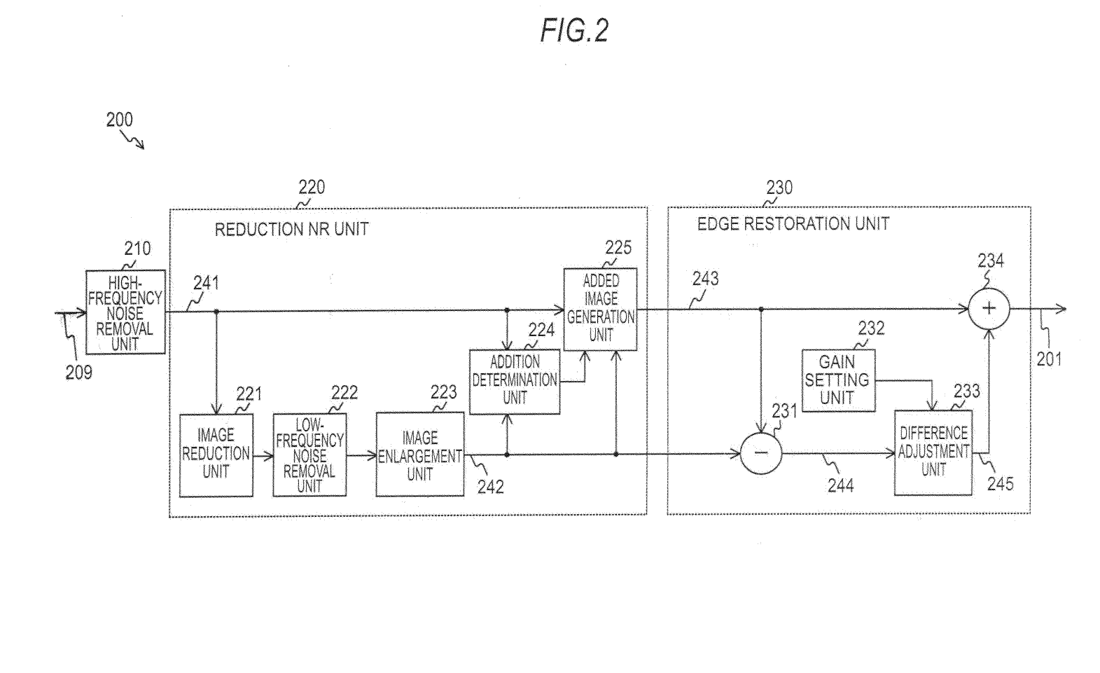

The internal configuration of the NR unit 200 will be described referring to FIG. 2, thus detailed description of the NR unit 200 herein will be omitted. The NR unit 200 supplies the image (hereinafter, referred to as an NR image) subjected to the noise removal processing and the unsharp mask processing to the size conversion unit 150 through a signal line 201.

The size conversion unit 150 converts the size of the NR image supplied from the NR unit 200 to the size of an image for recording or the size of an image for display. The size conversion unit 150 supplies the generated image for recording (recording image) to the recording processing unit 161. The size conversion unit 150 supplies the generated image for display (display image) to the display processing unit 171.

The recording processing unit 161 compresses and encodes the image supplied from the size conversion unit 150 to generate recording data. When recording a still image, the recording processing unit 161 compresses the image using an encoding format (for example, JPEG (Joint Photographic Experts Group) system) which is used to compress the still image, and supplies data (still image content) of the compressed image to the recording unit 162. When recording a motion image, the recording processing unit 161 compresses the image using an encoding format (for example, MPEG (Moving Picture Experts Group) system) which is used to compress the motion image, and supplies data (motion image content) of the compressed image to the recording unit 162.

When reproducing an image stored in the recording unit 162, the recording processing unit 161 restores the image by the compression encoding format of the image, and supplies the restored image signal to the display processing unit 171.

The recording unit 162 records recording data (still image content or motion image content) supplied from the recording processing unit 161. The recording unit 162 is realized by, for example, a recording medium (single or a plurality of recording mediums), such as a semiconductor memory (memory card or the like), an optical disc (a BD (Blu-ray Disc), a DVD (Digital Versatile Disc), a CD (Compact Disc), or the like)), or a hard disk. The recording mediums may be embedded in the imaging apparatus 100 or may be detachable from the imaging apparatus 100.

The display processing unit 171 converts the image supplied from the size conversion unit 150 to a signal for display on the display unit 172. For example, the display processing unit 171 converts the image supplied from the size conversion unit 150 to a standard color video signal of an NTSC (National Television System Committee) system, and supplies the converted standard color video signal to the display unit 172. When reproducing the image recorded in the recording unit 162, the display processing unit 171 converts the image supplied from the recording processing unit 161 to a standard color video signal, and supplies the converted standard color video signal to the display unit 172.

The display unit 172 displays the image supplied from the display processing unit 171. For example, the display unit 172 displays a monitor image (live view image), a setup screen of various functions of the imaging apparatus 100, a reproduced image, or the like. The display unit 172 is realized by, for example, a color liquid crystal panel, such as an LCD (Liquid Crystal Display) or an organic EL (Electro-Luminescence).

The preprocessing unit 130, the YC conversion unit 140, the NR unit 200, the size conversion unit 150, the recording processing unit 161, and the display processing unit 171 in the functional configuration are realized by, for example, a DSP (Digital Signal Processor) for image processing which is provided in the imaging apparatus 100.

In FIG. 1 and the subsequent drawings, an example where it is assumed that the NR unit 200 is provided in the imaging apparatus, and a captured image is processed will be described. However, the NR unit 200 may be provided in a video viewing apparatus (for example, a recorder with a hard disk) or the like which records or displays motion image content input from the outside. When the NR unit 200 is provided in the video viewing apparatus, the NR unit 200 is provided in a DSP for image processing which generates an image from recording data recorded in a recording medium. When generating a display image from recording data, noise removal processing and unsharp mask processing are performed.

Next, the internal configuration of the NR unit 200 will be described referring to FIG. 2.

### [Functional Configuration Example of NR Unit]

FIG. 2 is a block diagram schematically showing a functional configuration example of the NR unit 200 according to the first embodiment of the present technology.

In FIG. 2 and the subsequent drawings, description will be provided referring to a signal to be processed by the NR unit 200 as a pixel value. For example, when the NR unit 200 performs correction processing on the luminance component (Y), the value of the luminance component (Y) corresponds to a pixel value.

The NR unit 200 includes a high-frequency noise removal unit 210, a reduction NR unit 220, and an edge restoration unit 230.

The high-frequency noise removal unit 210 removes high-frequency noise from among noise included in the image supplied through the signal line 209. High-frequency noise can be removed while the number of taps is set to be small during filter processing when removing noise. High-frequency noise is noise which is generated in terms of pixels, such as one pixel or two pixels.

For example, the high-frequency noise removal unit 210 removes high-frequency noise using a ε filter with a small number of taps. The high-frequency noise removal unit 210 supplies an image with high-frequency noise removed to the reduction NR unit 220 through a signal line 241. Hereinafter, an image with high-frequency noise removed by the high-frequency noise removal unit 210 is referred to as a high-frequency noise-removed image.

The reduction NR unit 220 removes low-frequency noise in an image supplied from the high-frequency noise removal unit 210 using a reduced image of the image. Low-frequency noise is patchy noise which appears in a plurality of adjacent pixels (wide range), and is unable to be removed by a filter with a small number of taps. Low-frequency noise is noise which is not removed by the high-frequency noise removal unit 210, and for example, appears when a dark subject is captured with high sensitivity.

The reduction NR unit 220 includes an image reduction unit 221, a low-frequency noise removal unit 222, an image enlargement unit 223, an addition determination unit 224, and an added image generation unit 225. The reduction NR unit 220 supplies an image with low-frequency noise removed and a reduced image to the edge restoration unit 230. The reduction NR unit 220 is an example of a noise-removed image generation unit described in the appended claims.

The image reduction unit 221 generates a reduced image by reducing the size of the image supplied through the signal line 241 1/N times. For example, the image reduction unit 221 generates a reduced image by reducing the supplied image to ¼ size. The reduction ratio (N) is a value such that a frequency which acts as a criterion (boundary) for band limitation in a section of a major frequency component at a near edge (a frequency such that a frequency component equal to or greater than the frequency is cut) is set. The image reduction unit 221 supplies the generated reduced image to the low-frequency noise removal unit 222.

The low-frequency noise removal unit 222 removes noise which is included in the reduced image supplied from the image reduction unit 221. Since high-frequency noise is removed in the high-frequency noise removal unit 210, low-frequency noise included in the image is removed by noise removal in the low-frequency noise removal unit 222. As a noise removal method, various methods are considered, and for example, the low-frequency noise removal unit 222 removes noise using a ε filter in the same manner as in the high-frequency noise removal unit 210. Since an image subjected to noise removal processing is a reduced image, the generation range (number of pixels) of low-frequency noise becomes smaller than before reduction (¼). For this reason, low-frequency noise can be removed by a filter with a small number of taps by filter processing of the reduced image. The low-frequency noise removal unit 222 supplies the reduced image with low-frequency noise removed to the image enlargement unit 223.

The image enlargement unit 223 enlarges the reduced image supplied from the low-frequency noise removal unit 222 N times to convert the reduced image to an image of original size. For example, when the reduced image is reduced ¼ times in the image reduction unit 221, the image enlargement unit 223 enlarges the size of the reduced image four times. Hereinafter, an image which is enlarged by the image enlargement unit 223 after low-frequency noise is removed by the low-frequency noise removal unit 222 is referred to as a low-frequency noise-removed image. The image enlargement unit 223 supplies the generated image (hereinafter, referred to as a low-frequency noise-removed image) to the addition determination unit 224, the added image generation unit 225, and the edge restoration unit 230 through a signal line 242.

The addition determination unit 224 determines a blending ratio (addition ratio) of the high-frequency noise-removed image supplied from the high-frequency noise removal unit 210 through the signal line 241 and the low-frequency noise-removed image supplied from the image enlargement unit 223 through the signal line 242 for each pixel value (for each pixel). As a method which calculates the addition ratio, various methods are considered. For example, a method which determines the addition ratio for each pixel using the high-frequency noise-removed image or the low-frequency noise-removed image, a method which determines the addition ratio from external information (imaging conditions, such as imaging in a flesh color definition mode), or the like is considered. A method which determines the addition ratio for each pixel using the high-frequency noise-removed image or the low-frequency noise-removed image and modulates the value using external information, or the like is also considered. As an example, description will be provided assuming that the addition ratio is calculated for each pixel using the high-frequency noise-removed image and the low-frequency noise-removed image.

The addition determination unit 224 calculates the addition ratio S such that “0≦S≦1” is satisfied. For example, the addition determination unit 224 calculates the addition ratio S for each pixel using Expression (1).

S=|(P_{IN}−P_{LOW})×f| (1)

P_{IN} is a pixel value in the high-frequency noise-removed image. P_{LOW} is a pixel value in the low-frequency noise-removed image. f is a conversion factor.

In the calculation of the addition ratio S using Expression 1, when the conversion factor f is set such that the calculation result of the left side may become greater than “1.0”, saturation processing is performed with 1.0. If the addition ratio S is calculated using Expression 1, the addition ratio S becomes a value close to “1” at an edge of an image, becomes a value close to “0” in a flat portion, and becomes “0<S<1” at a near edge.

The addition determination unit 224 calculates the addition ratio for all pixel values constituting an image (high-frequency noise-removed image) of original size, and supplies the calculated addition ratio to the added image generation unit 225.

The added image generation unit 225 adds the high-frequency noise-removed image and the low-frequency noise-removed image in accordance with the addition ratio, and generates an image (image after reduction NR) with noise removed. For example, the added image generation unit 225 calculates a pixel value (P_{NR}) in the image after reduction NR for each pixel using Expression (2).

P_{NR}=S×P_{IN}+(1−S)×P_{LOW} (2)

From Expression 2, when the addition ratio S is “1”, the pixel value in the high-frequency noise-removed image is output directly as the pixel value of the image after reduction NR. When the addition ratio S is “0”, the pixel value in the low-frequency noise-removed image is output directly as the pixel value of the image after reduction NR.

That is, from Expression 2, in regard to the pixel values at the edge at which the addition ratio S is a value close to “1”, the ratio of the pixel values in the high-frequency noise-removed image increases. In regard to the pixel values in the flat portion in which the addition ratio S is a value close to “0”, the ratio of the pixel values in the low-frequency noise-removed image increases. In a near-edge portion in which the addition ratio S becomes “0<S<1”, the pixel values in the high-frequency noise-removed image and the pixel values in the low-frequency noise-removed image become the pixel values which are blended in accordance with the addition ratio S. In this way, the addition ratio S represents the level of edge, as the level is high, the ratio resulting from the high-frequency noise-removed image increases.

The added image generation unit 225 supplies the image (image after reduction NR) generated by addition to the edge restoration unit 230 through a signal line 243.

The edge restoration unit 230 restores resolution at the edge and the near edge in the image after reduction NR. Since the image after reduction NR is generated by blending the high-frequency noise-removed image and the low-frequency noise-removed image, high-frequency noise and low-frequency noise are reduced. Meanwhile, as the ratio of the pixel value of the low-frequency noise-removed image is high, resolution (high-frequency component) is lowered. Accordingly, the edge restoration unit 230 restores resolution at the edge and the near edge by unsharp mask processing.

The edge restoration unit 230 includes a subtractor 231, a gain setting unit 232, a difference adjustment unit 233, and an adder 234. The edge restoration unit 230 is an example of a corrected image generation unit described in the appended claims.

The subtractor 231 performs subtraction with the image after reduction NR supplied from the added image generation unit 225 through the signal line 243 and the low-frequency noise-removed image supplied from the image enlargement unit 223 through the signal line 242, and calculates a difference value for unsharp mask processing for each pixel. The subtractor 231 supplies the calculated difference value to the difference adjustment unit 233 through a signal line 244.

The gain setting unit 232 determines a value (gain) which adjusts the difference value for each pixel. As a method which calculates the gain, various methods are considered, and for example, a method which determines the gain for each pixel using the image after reduction NR or the low-frequency noise-removed image, a method which determines the gain from external information, such as lens characteristics, or the like is considered. A method which determines the gain for each pixel using the image after reduction NR or the low-frequency noise-removed image and modulates the gain using external information, or the like is considered.

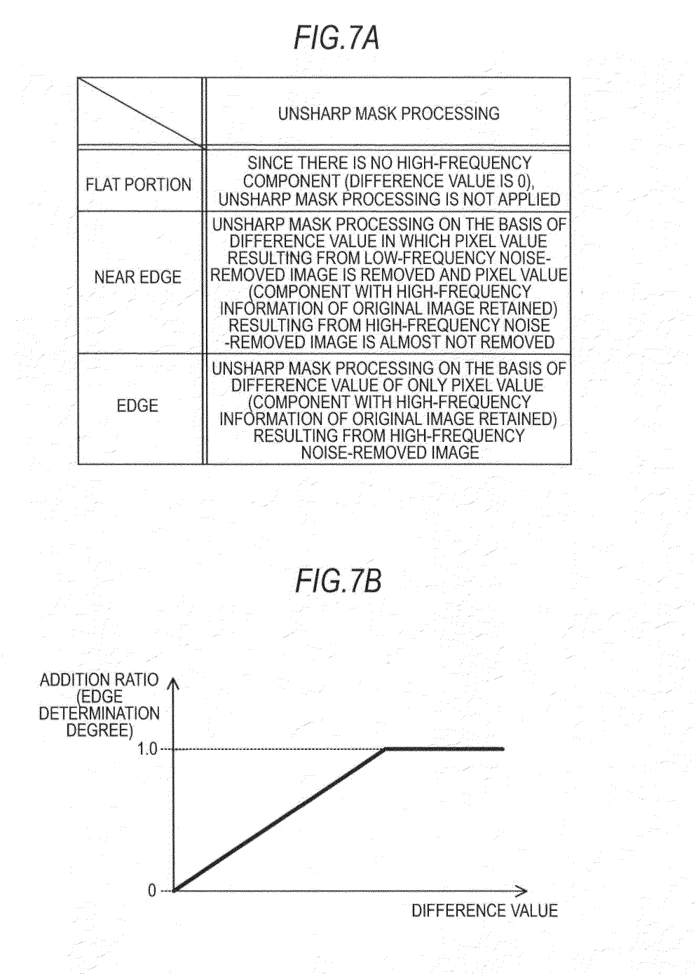

As an example, it is assumed that the gain is determined on the basis of the positive/negative and the magnitude of the value of the difference between the image after reduction NR and the low-frequency noise-removed image. If the gain is determined in this way, for example, adjustment can be performed such that the level of enhancement by unsharp mask processing decreases in a pixel value in which the difference is positive, and the level of enhancement by unsharp mask processing increases in a pixel value in which the difference is negative (see FIGS. 7A and 7B). The gain setting unit 232 supplies the set gain for each pixel to the difference adjustment unit 233.

The difference adjustment unit 233 adjusts the difference value supplied from the subtractor 231 through the signal line 244 on the basis of the gain supplied from the gain setting unit 232. For example, the difference adjustment unit 233 calculates a difference value E subjected to gain adjustment for each pixel value using Expression (3).

E=D×G (3)

D is a difference value and is a value of the calculation result of P_{NR}−P_{LOW} by the subtractor 231. G is a gain set by the gain setting unit 232.

The difference adjustment unit 233 performs gain adjustment on the difference value for each pixel using Expression 3, and supplies the difference value subjected to gain adjustment to the adder 234.

The adder 234 generates an image with an edge restored on the basis of the image after reduction NR supplied from the added image generation unit 225 through the signal line 243 and the difference value after gain adjustment supplied from the difference adjustment unit 233. For example, the difference adjustment unit 233 calculates a pixel value Pₒᵤₜ using Expression 4 and generates an image (NR image) with an edge restored.

Pₒᵤₜ=P_{NR}+E (4)

In this way, the difference value subjected to gain adjustment is added to the pixel values of the image after reduction NR, whereby unsharp mask processing is performed and resolution at the edge and the near edge is restored. The adder 234 outputs an image (NR image) having the added pixel values from the NR unit 200 through the signal line 201.

Next, an edge, a near edge, and a flat portion in an image will be described referring to FIGS. 3A and 3B.

### [Example of Image Representing Edge, Near Edge, and Flat Portion]

FIGS. 3A and 3B are diagrams illustrating an edge, a near edge, and a flat portion which are used to illustrate image processing in the NR unit 200 according to the first embodiment of the present technology.

FIG. 3A shows an image (image 310) for illustrating an edge, a near edge, and a flat portion, and a distribution waveform (distribution waveform 314) of pixel values in this image. In the distribution waveform 314, the vertical axis direction represents intensity of a pixel value, and the horizontal axis direction represents a pixel position in the image 310.

In the image 310, a black line is drawn in an image of a white background, the white background corresponds to a flat portion (flat portion 311), the black line corresponds to an edge (edge 313), and a region with minute dots at the boundary of the white background and the black line corresponds to a near edge (near edge 312). As shown in the distribution waveform 314, in the flat portion 311, there is little difference in intensity of the pixel value from a surrounding pixel. As shown in the distribution waveform 314, at the edge 313, there is a large difference in the intensity of the pixel value from the pixel of the flat portion 311, and at the near edge 312, the pixel value is transited so as to keep the difference in the pixel value between the edge 313 and the flat portion 311.

FIG. 3B shows photographs (photographs 320 and 321), in which a building and the sky are imaged, so as to illustrate an edge, a near edge, and a flat portion. An edge, a near edge, and a flat portion will be described focusing on the boundary between the building and the sky.

The photograph 320 is a photograph in which a mark for representing an edge or a near edge is not added at the boundary between the building and the sky, and the photograph 321 is a photograph in which a mark for representing an edge or a near edge is added. At the boundary between the building and the sky, the edge corresponds to the boundary between the building and the sky. Near the edge corresponds to the near edge, and the flat portion corresponds to the region of the sky (the flat portion 331 of the photograph 321). In the photograph 321, an edge is represented by a black solid line (edge 333), and a near edge is represented by a dotted-line region (near edge 332).

In this way, the captured image includes the edge, the near edge, and the flat portion. The edge and the near edge include high-frequency components, and when removing low-frequency noise using a reduced image, if the image is replaced with a reduced image, the high-frequency components are removed and the image is blurred. For this reason, the reproduction of the high-frequency components at the edge and the near edge is important.

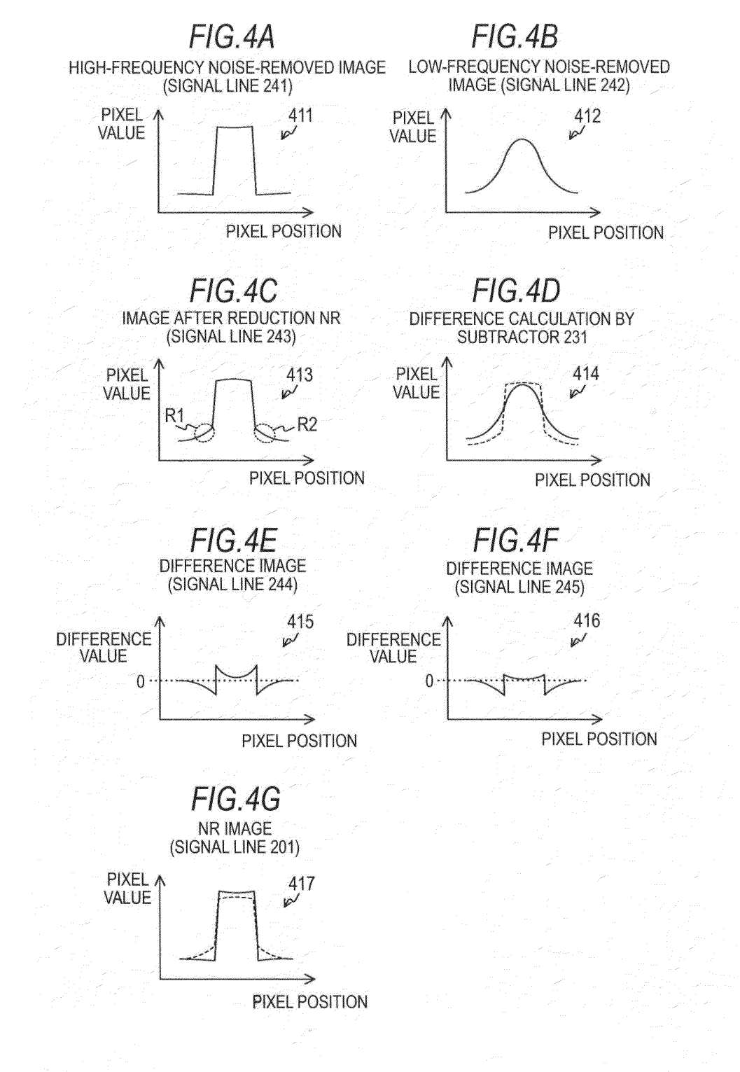

Next, reduction NR processing and unsharp mask processing by the NR unit 200 will be described referring to FIGS. 4A to 4G schematically showing transition of a pixel value in an image.

### [Example of Transition of Pixel Value]

FIGS. 4A to 4G are diagrams schematically showing transition of a pixel value during reduction NR processing and unsharp mask processing by the NR unit 200 according to the first embodiment of the present technology.

In graphs shown in FIGS. 4A to 4G, the horizontal axis represents a pixel position, and the vertical axis represents a pixel value.

In a graph 411 shown in FIG. 4A, a solid line schematically showing a pixel value in a high-frequency noise-removed image is shown. In FIGS. 4A to 4G, description will be provided assuming that the pixel value is subjected to reduction NR processing and unsharp mask processing by the NR unit 200. In the solid line shown in the graph 411, two positions where the pixel value changes rapidly are edges, left and right positions close to the edge are near edges, and both left and right ends of the solid line correspond to flat portions.

In a graph 412 shown in FIG. 4B, a solid line schematically showing a pixel value in a low-frequency noise-removed image is shown. As shown in the graph 412, in an image which is reduced and then returned to original size after low-frequency noise is removed, the image is blurred at the edge and the near edge.

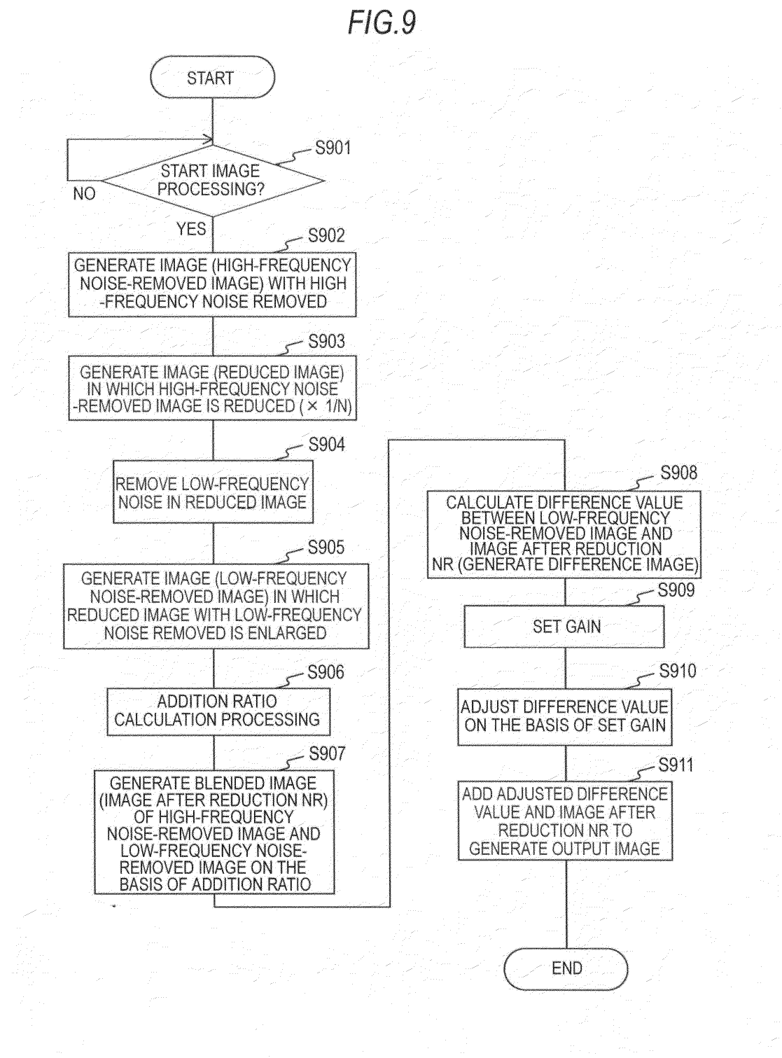

In a graph 413 shown in FIG. 9C, a solid line schematically showing a pixel value in an image after reduction NR is shown. As shown in the graph 413, in an image after reduction NR generated by blending a high-frequency noise-removed image and a low-frequency noise-removed image, the pixel value changes significantly at the near edge. In particular, as shown in regions R1 and R2 in the graph 413, the pixel value changes from a low pixel value to a high pixel value (the upper side of the drawing), and the pixel value is floated.

In a graph 414 shown in FIG. 4D, in order to schematically show difference calculation by the subtractor 231, the pixel value of an image after reduction NR is represented by a broken line, and the pixel value of a low-frequency noise-removed image is represented by a solid line. In the subtractor 231, the difference between the image after reduction NR and the low-frequency noise-removed image is calculated, and a difference value as a graph 415 shown in FIG. 4E is generated.

In the graph 415 shown in FIG. 4E, a solid line schematically showing a pixel value (difference value) in a difference image generated by the subtractor 231 is shown. As shown in the graph 415, the difference is greatest (significantly deviated from the value “0”) at the edge, and the difference is smallest (substantially the value “0”) in the flat portion. At the near edge, the difference is intermediate between the difference of the edge and the difference of the flat portion.

In a graph 416 shown in FIG. 4F, a solid line schematically showing a pixel value (difference value) in a difference image subjected gain adjustment by the difference adjustment unit 233 is shown. As shown in the graph 416, in the gain adjustment by the difference adjustment unit 233, gain adjustment is made such that a pixel value to be added decreases at a position where the value of the difference is positive, and a pixel value to be subtracted (addition of a negative value) increases at a position where the value of the difference is negative.

In a graph 417 shown in FIG. 4G, a solid line schematically showing a pixel value in an NR image and a broken line schematically showing a pixel value in an image after reduction NR are shown. As shown in the graph 417, the image after reduction NR is subjected to unsharp mask processing, whereby the difference in the pixel value is enlarged, and a feeling of contrast is provided. In general, the unsharp mask processing is used when enhancing the contrast of the entire image or when enhancing the contour (edge). In the first embodiment of the present technology, the low-frequency noise-removed image is used in the addition of the reduction NR unit 220, and the low-frequency noise-removed image is used in the unsharp mask processing, whereby the determination criterion at the near edge is uniform in the reduction NR processing and the unsharp mask processing. Accordingly, in a pixel value determined to be a flat portion in the reduction NR processing, since the unsharp mask processing is not applied, enhancement is not made. In a pixel value determined to be an edge or a near edge in the reduction NR processing, the level (addition ratio) of determination is reflected in the difference value, and enhancement is made by the unsharp mask processing according to the level of determination in the reduction NR processing.

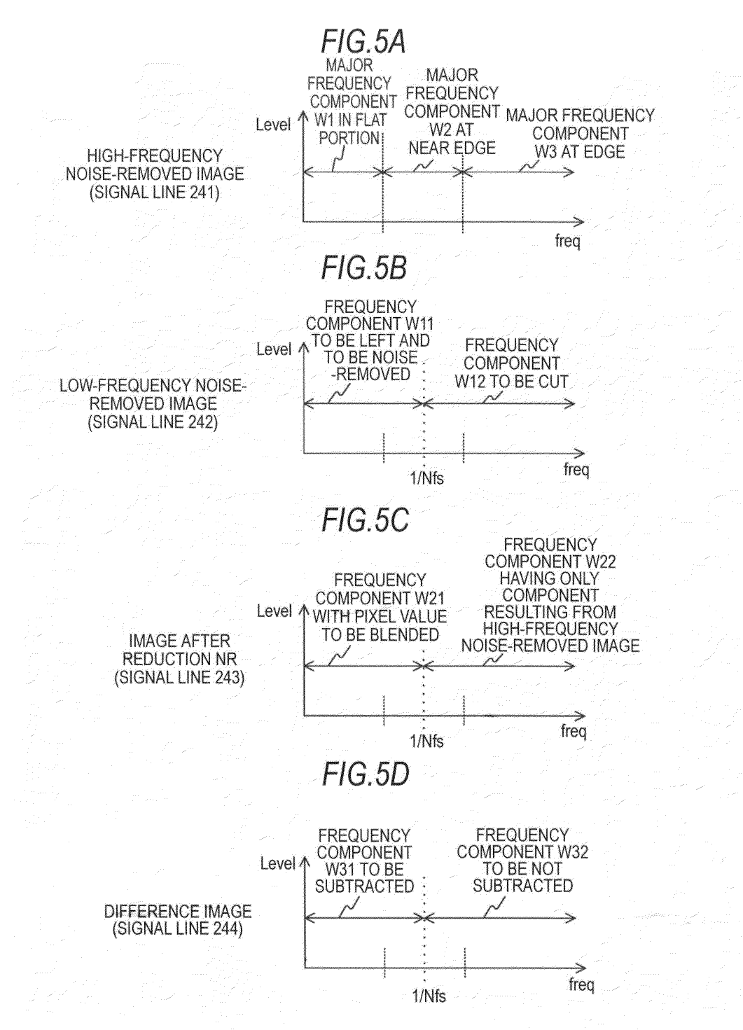

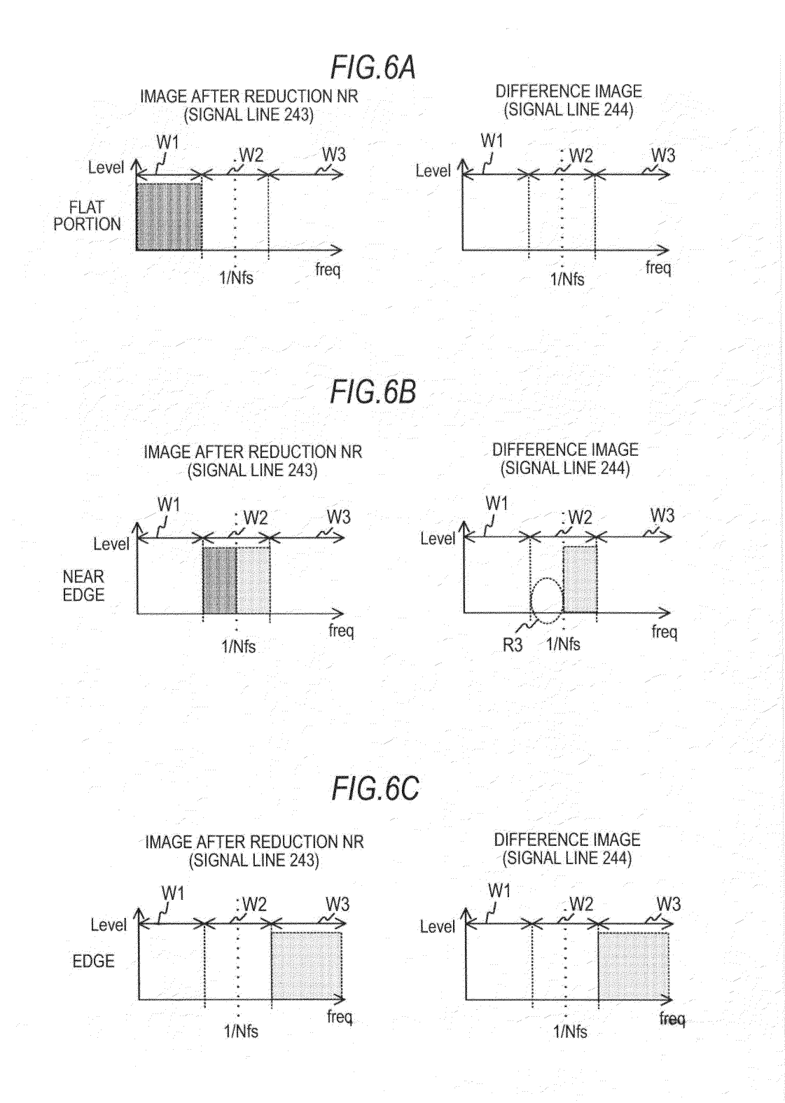

Next, image processing (reduction NR processing and unsharp mask processing) in the NR unit 200 will be described referring to FIGS. 5A to 5D and 6A to 6C focusing on a frequency component of an image.

### [Relationship Example of Frequency Component and Image Processing]

FIGS. 5A to 5D are diagrams schematically showing the relationship between a frequency component of an image and image processing so as to illustrate image processing in the NR unit 200 according to the first embodiment of the present technology.

In FIGS. 5A to 5D, each kind of image processing will be described classifying a frequency component into a plurality of sections in a graph in which the horizontal axis represents a wavelength and the vertical axis represents intensity. FIGS. 5A to 5D are focused on the sections, thus a waveform representing signal intensity at each wavelength is not shown.

FIG. 5A shows the relationship between a frequency component and each imaging region (edge, near edge, and flat portion) in an image. In a graph shown in FIG. 5A, a section (section W1) of a major frequency component in the flat portion, a section (section W2) of a major frequency component at a near edge, and a section (section W3) of a major frequency component at an edge are shown. As shown in FIG. 5A, a low-frequency component is majority in the flat portion, and a high-frequency component is majority at the edge. At the near edge, a frequency component at a frequency between a major frequency in the flat portion and a major frequency at the edge is majority.

FIG. 5B shows the relationship between a frequency component of an image (low-frequency noise-removed image) enlarged after reduction NR and band limitation by reduction. When a high-frequency noise-removed image is reduced 1/N times, a frequency component is band-limited to 1/N. That is, the image reduction unit 221 reduces the high-frequency noise-removed image 1/N times, whereby a frequency component (the right side of 1/Nfs) higher than a predetermined frequency (1/Nfs in a graph of FIG. 5B) is cut (removed).

If noise removal is performed using this image, noise in a frequency component (section W11) lower than 1/Nfs is removed. After noise is removed, even if the image is returned to original size by the image enlargement unit 223, a frequency component (section W12) higher than 1/Nfs remains cut. Accordingly, the frequency components of the low-frequency noise-removed image are constituted only by frequency components (section 11) lower than 1/Nfs, and there are no frequency component (section W12) higher than 1/Nfs.

FIG. 5C shows the relationship between a frequency component of an image after reduction NR, which is generated by blending a high-frequency noise-removed image and a low-frequency noise-removed image, and the high-frequency noise-removed image and the low-frequency noise-removed image. As shown in FIG. 5B, the low-frequency noise-removed image to be blended includes only frequency components (the section W11 of FIG. 5B) lower than 1/Nfs. The high-frequency noise-removed image to be blended includes both frequency components lower than 1/Nfs and frequency components higher than 1/Nfs.

If the two images are added (blended) in accordance with the addition ratio S, a frequency component (a section W21 of FIG. 5C) lower than 1/Nfs becomes a frequency component in which the frequency component of the low-frequency noise-removed image and the frequency component of the high-frequency noise-removed image are blended. A frequency component (a section W22 of FIG. 5C) higher than 1/Nfs becomes a frequency component in which the addition ratio is reflected in a frequency component of the high-frequency noise-removed image higher than 1/Nfs. That is, the section W22 becomes frequency components which are constituted only by components resulting from the high-frequency noise-removed image.

FIG. 5D shows the relationship between a subtraction operation which is performed by the subtractor 231 and a frequency component of an image (difference image) generated by the subtraction. In the subtractor 231, subtraction is performed between the low-frequency noise-removed image and the image after reduction NR. Since the low-frequency noise-removed image includes only the frequency components lower than 1/Nfs, in a frequency component lower than 1/Nfs, frequency component subtraction is performed. That is, frequency components represented by a section W31 are frequency components which are subjected to subtraction when generating a difference image.

In regard to frequency components (a section W32 of FIG. 5D) higher than 1/Nfs, the frequency components higher than 1/Nfs are not included in the low-frequency noise-removed image, frequency component subtraction is not performed. For this reason, a difference image is an image in which a frequency component of the image after reduction NR higher than 1/Nfs is reflected.

Next, the relationship between three regions (flat portion, near edge, and edge) of an image and image processing will be described referring to FIGS. 6A to 6C.

### [Example of Frequency Component in Difference Image]

FIGS. 6A to 6C are diagrams schematically showing the relationship between a frequency component of a difference image and a frequency component of an image after reduction NR used for unsharp mask processing in the NR unit 200 according to the first embodiment of the present technology.

In FIGS. 6A to 6C, focusing on a band-limited frequency (1/Nfs in FIGS. 5A to 5D), the presence/absence of a frequency component higher than 1/Nfs is represented by a region with a small number of minute dots. The presence/absence of a frequency component lower than 1/Nfs is represented by a region with a large number of minute dots. The section W1 to the section W3 are the same as those shown in FIGS. 5A to 5D, thus description herein will not be repeated.

FIG. 6A shows a frequency component in a flat portion, FIG. 6B shows a frequency component at a near edge, and FIG. 6C shows a frequency component at an edge.

As shown in FIG. 6A, the flat portion of the image after reduction NR primarily has a frequency component in the section (section W1) of a major frequency component in the flat portion. The section W1 is a frequency component lower than a band-limited frequency (1/Nfs). The pixel value of each pixel is generated by Expression 2. For this reason, there is no major difference in the frequency component in the section W1 between the image after reduction NR and the low-frequency noise-removed image. For this reason, as shown in a graph of a difference image of FIG. 6A, there is almost no frequency component in the flat portion of the difference image.

Next, the near edge will be described. As shown in FIG. 6B, the near edge of the image after reduction NR primarily has a frequency component in the section (section W2) of a major frequency component at the near edge. Since the frequency (1/Nfs) of the criterion (boundary) of band limitation is within the section W2, a frequency component higher than 1/Nfs becomes a component from the high-frequency noise-removed image, and a frequency component lower than 1/Nfs becomes a component in which the high-frequency noise-removed image and the low-frequency noise-removed image are blended. Since blending is made using Expression 2, the frequency components lower than 1/Nfs are considerably similar between the image after reduction NR and the low-frequency noise-removed image. That is, most of the frequency components (the region R3 of FIG. 6B) lower than 1/Nfs at the near edge of the difference image is subtracted.

In the frequency components higher than 1/Nfs at the near edge of the difference image, since there are no frequency components higher than 1/Nfs in the image after reduction NR, components from the high-frequency noise-removed image remain in the difference image. When generating the image after reduction NR, since blending is made using the addition ratio, the addition ratio (level of edge) is reflected in the pixel values of the difference image corresponding to the remaining components.

Next, the edge will be described. As shown in FIG. 6C, the edge of the image after reduction NR primarily has a frequency component in the section (section W3) of a major frequency component at the edge. Since the section W3 is constituted by the frequency components higher than 1/Nfs, a frequency component of the image after reduction NR higher than 1/Nfs remains and becomes a frequency component of the difference image. Since there is no frequency component of the image after reduction NR higher than 1/Nfs, components of the high-frequency noise-removed image remain in the difference image. When generating the image after reduction NR, since blending is made using the addition ratio, similarly to the near edge, the addition ratio (level of edge) is reflected in the pixel values of the difference image corresponding to the remaining components.

In this way, band limitation (reduction ratio) when generating the low-frequency noise-removed image matches band limitation (reduction ratio) when generating the difference image (1/Nfs in FIGS. 6A to 6C), whereby the criterion of edge determination during the reduction NR processing can easily coincide with the criterion of edge determination during the unsharp mask processing.

### [Example of Details of Unsharp Mask Processing]

FIGS. 7A and 7B are diagrams schematically showing the details of the unsharp mask processing in the NR unit 200 according to the first embodiment of the present technology.

FIG. 7A is a table which represents the details of unsharp mask processing at each position of the flat portion, the near edge, and the edge. As shown in FIG. 7A, in the flat portion, since the difference value substantially becomes 0, the unsharp mask processing is not applied. At the near edge, unsharp mask processing is performed on the basis of a difference value in which a pixel value resulting from the low-frequency noise-removed image is removed and which primarily has a pixel value (a component with high-frequency information of an original image retained) resulting from the high-frequency noise-removed image. At the edge, unsharp mask processing is performed on the basis of a difference value which has only a pixel value (a component with high-frequency component of an original image retained) resulting from the high-frequency noise-removed image.

In this way, the unsharp mask processing is performed, whereby appropriate enhancement (contour enhancement) is performed only at the near edge and the edge. That is, resolution at the near edge which is lowered by the reduction NR processing can be restored.

FIG. 7B is a graph showing an example of the relationship between a difference value in a difference image and an addition ratio calculated by the addition determination unit 224 of the reduction NR unit 220.

The graph shown in FIG. 7B has the horizontal axis representing the magnitude of a difference value and the vertical axis representing an addition ratio, and the relationship between the difference value and the addition ratio is indicated by a bold solid line. As expressed by Expression 2 (see FIG. 2), the addition ratio is a value which represents the blending ratio, and has a maximum value of 1 and a minimum value of 0. The addition ratio is a value which represents the result of edge determination when generating a reduction NR image by blending. Since the high-frequency noise-removed image and the low-frequency noise-removed image are blended in accordance with the addition ratio, a difference value with a majority of components resulting from the high-frequency noise-removed image is calculated, whereby a difference value in which edge determination (addition ratio) in the reduction NR unit 220 is reflected can be calculated. The unsharp mask processing is performed using the difference value in which edge determination in the reduction NR unit 220 is reflected is performed, whereby the result of edge determination in the reduction NR unit 220 can be reflected in the unsharp mask processing.

In this way, the level of edge determination during the reduction NR processing can be equal as the level of edge determination during the unsharp mask processing, thus appropriate enhancement of the near edge and the edge can be performed.

### [Effect Example Using Same Band Limitation During Reduction NR Processing and Unsharp Mask Processing]

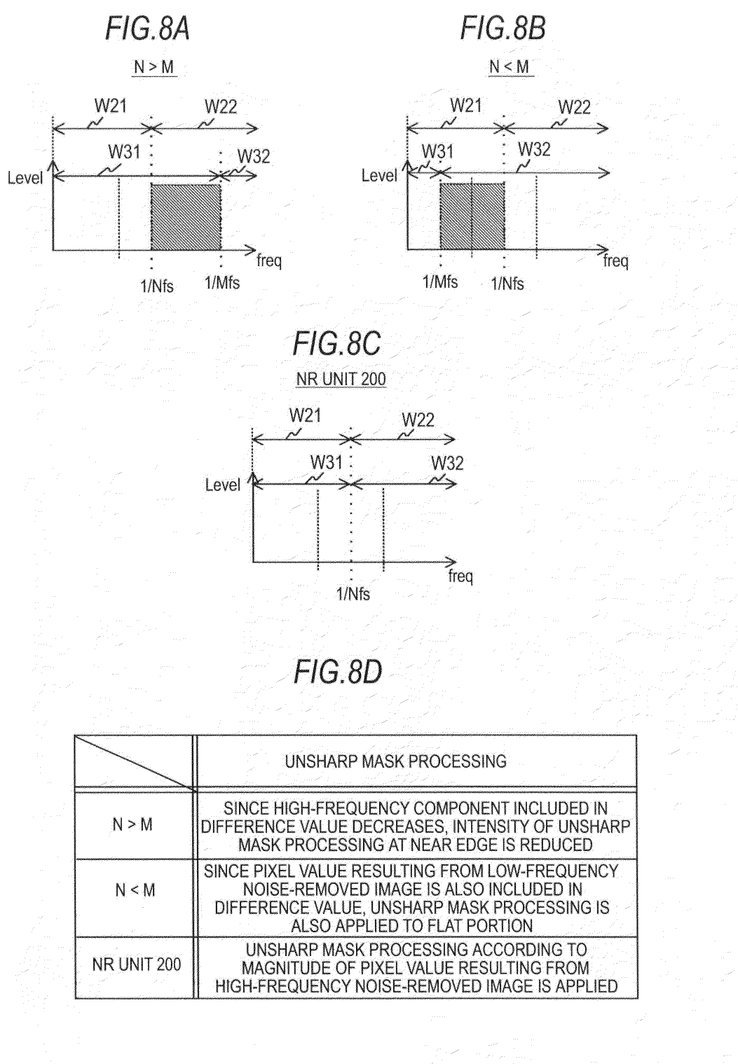

FIGS. 8A to 8D are diagrams illustrating the effects of the use of the same band limitation during reduction NR processing and unsharp mask processing in the NR unit 200 according to the first embodiment of the present technology.

FIGS. 8A and 8B show an example where a reduction ratio (N) of a reduced image necessary for performing reduction NR processing is different from a reduction ratio (M) of a reduced image for generating a blurred image during unsharp mask processing after reduction NR. FIG. 8A shows a case where N>M, and FIG. 8B shows a case where N<M.

FIG. 8C shows a case of the NR unit 200 shown in FIGS. 5A to 5D and 6A to 6C. The sections (sections W21, W22, W31, and W32) shown in FIGS. 8A to 8C correspond to the sections shown in FIGS. 5A to 5D, thus description herein will not be repeated.

As shown in FIG. 8A, in a case of N>M, the frequency (1/Mfs) of the criterion (boundary) of band limitation of the unsharp mask processing is higher than the frequency (1/Nfs) of the criterion (boundary) of band limitation of the reduction NR processing. That is, a region (a hatched region of FIG. 8A) where a frequency component (section W31) to be subtracted when generating the difference image overlaps a frequency component (section W22) having only component resulting from the high-frequency noise-removed image during the image after reduction NR occurs. Accordingly, since a frequency component which becomes a difference value decreases, the unsharp mask processing as described in FIGS. 7A and 7B is not made.

As shown in FIG. 8B, in a case of N<M, the frequency (1/Mfs) of the criterion (boundary) of band limitation of the unsharp mask processing is lower than the frequency (1/Nfs) of the criterion (boundary) of band limitation of the reduction NR processing. That is, a region (a hatched region of FIG. 8B) where a frequency component (section W32) to be not subtracted when generating the difference image overlaps a blended frequency component (section W21) in the generation of the image after reduction NR occurs. Accordingly, since frequency components which become a difference value increase, the unsharp mask processing as described in FIGS. 7A and 7B is not made.

FIG. 8D is a table which represents the details of unsharp mask processing in a case of N>M shown in FIG. 8A, a case of N<M shown in FIG. 8B, and a case where the same band limitation is used during reduction NR processing and unsharp mask processing (a case of the NR unit 200).

As shown in FIG. 8D, in a case of N>M, since the high-frequency components included in the difference value decrease, the intensity of the unsharp mask processing at the near edge is weakened. In a case of N<M, since a pixel value resulting from the low-frequency noise-removed image is also included in the difference value, the flat portion is also subjected to the unsharp mask processing (enhanced). In a case of N>M or N<M, there is no relationship between the addition ratio and the difference value shown in FIG. 7B. For this reason, even if the gain which is set in the gain setting unit 232 is adjusted, it is difficult to make the level of edge determination during the reduction NR processing and the level of edge determination during the unsharp mask processing the same, and it is difficult to perform appropriate enhancement of the near edge and the edge.

### [Operation Example of NR Unit]

Next, the operation of the NR unit 200 according to the first embodiment of the present technology will be described referring to the drawings.

FIG. 9 is a flowchart showing a processing procedure example when image processing is performed by the NR unit 200 according to the first embodiment of the present technology.

First, it is determined whether or not to start image processing (Step S901), and when it is determined not to start the image processing, it waits for starting the image processing.

When it is determined to start image processing (Step S901), an image (high-frequency noise-removed image) with high-frequency noise removed is generated by the high-frequency noise removal unit 210 (Step S902). For example, when image data to be processed is supplied, it is determined to start image processing, and the high-frequency noise-removed image is generated by the high-frequency noise removal unit 210.

Next, an image (reduced image) which is obtained by reducing (×1/N) the high-frequency noise-removed image is generated by the image reduction unit 221 (Step S903). Thereafter, low-frequency noise in the reduced image is removed by the low-frequency noise removal unit 222 (Step S904). Subsequently, an image (low-frequency noise-removed image) which is obtained by enlarging (×N) the reduced image with low-frequency noise removed is generated by the image enlargement unit 223 (Step S905). Step S904 is an example of generating a noise-removed image described in the appended claims.

The addition ratio is calculated by the addition determination unit 224 (Step S906). Thereafter, an image (image after reduction NR) which is obtained by blending the high-frequency noise-removed image and the low-frequency noise-removed image on the basis of the addition ratio is generated by the added image generation unit 225 (Step S907).

Subsequently, the difference (difference image) between the low-frequency noise-removed image and the image after reduction NR is calculated by the subtractor 231 (Step S908). Thereafter, a value (gain) which adjusts the difference value for addition during the unsharp mask processing is set by the gain setting unit 232 (Step S909). Subsequently, the difference value is adjusted on the basis of the set gain by the difference adjustment unit 233 (Step S910). An image (output image) which is obtained by adding the adjusted difference value and the image after reduction NR is generated by the adder 234 (Step S911), and the processing procedure of the image processing by the NR unit 200 ends. Steps S908 to S911 are an example of generating a corrected image described in the appended claims.

In this way, according to the first embodiment of the present technology, the reduced images which are used in the reduction NR processing and the unsharp mask processing have the same reduction ratio, it is possible to remove low-frequency noise, and to appropriately enhance the edge and the near edge. That is, according to the first embodiment of the present technology, it is possible to improve image quality in an image subjected to noise removal processing.

### 2. Second Embodiment

In the first embodiment of the present technology, an example where the reduced images which are used in the reduction NR processing and the unsharp mask processing have the same reduction ratio, and the two kinds of processing have the same level of edge determination has been described. Accordingly, it becomes possible to enhance the edge and the near edge in the unsharp mask processing.

There may be an attempt to enhance the contrast of the entire image in the unsharp mask processing depending on image quality of the captured image. However, in the method according to the first embodiment of the present technology, it is not possible to enhance the contrast of the entire image.

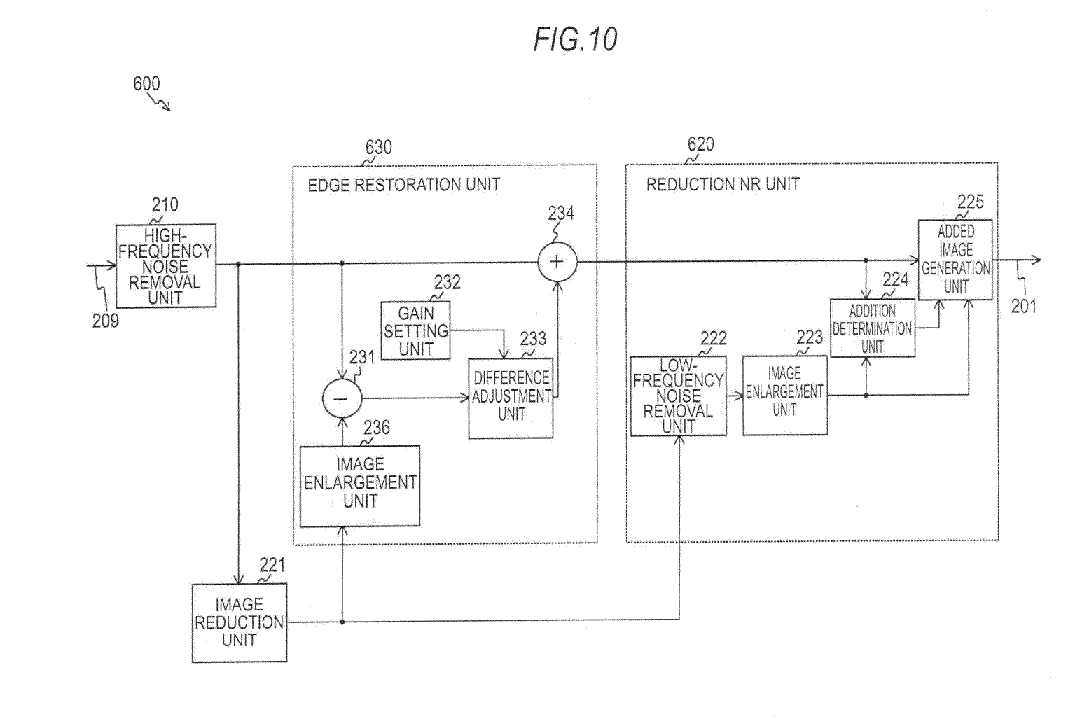

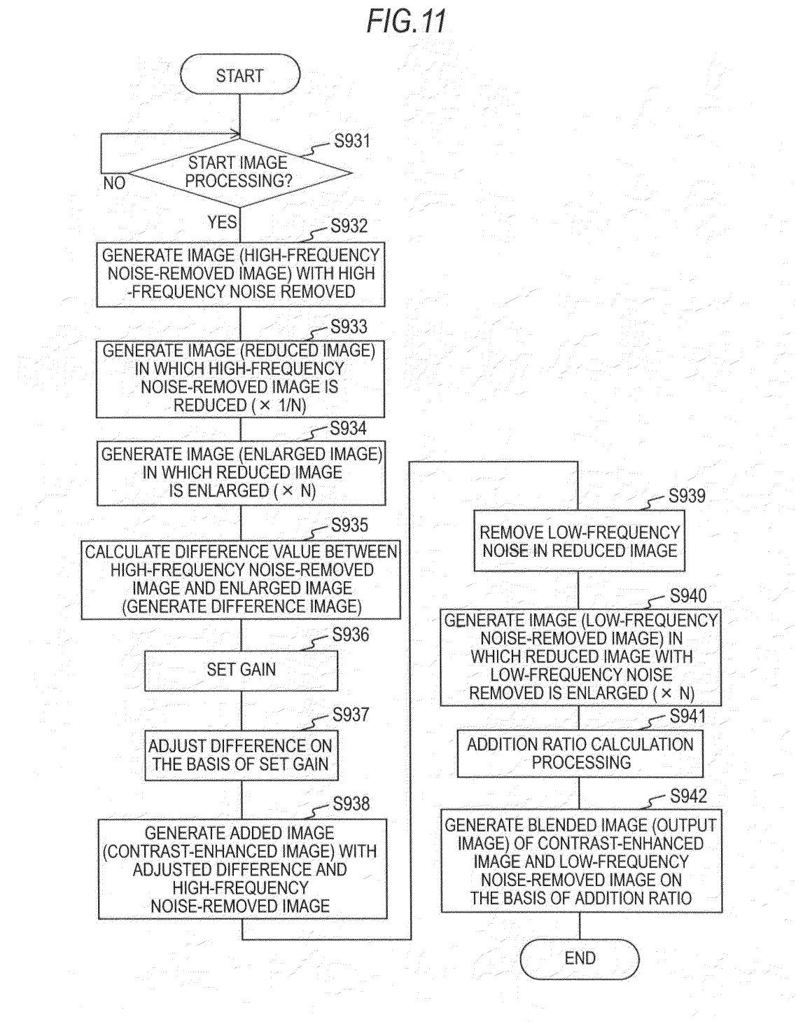

Accordingly, in a second embodiment of the present technology, an example where the contrast of the entire image is enhanced and low-frequency noise is removed during the reduction NR processing will be described referring to FIGS. 10 and 11.

### [Functional Configuration Example of NR Unit]

FIG. 10 is a block diagram showing an example of the functional configuration of an NR unit 600 according to the second embodiment of the present technology.

The NR unit 600 is a modification of the NR unit 200 shown in FIG. 2. Accordingly, the same parts as those of the NR unit 200 of FIG. 2 will be represented by the same reference numerals, and description herein will not be repeated.

The NR unit 600 is different from the NR unit 200 of FIG. 2 in that the processing sequence of the reduction NR processing and the unsharp mask processing are reversed. That is, in the NR unit 600, after high-frequency noise is removed by the high-frequency noise removal unit 210, the unsharp mask processing is performed, and then the reduction NR processing is carried out.

In the NR unit 600, an edge restoration unit 630 which performs the unsharp mask processing includes an image enlargement unit 236 which enlarges the reduced image supplied from the image reduction unit 221, in addition to the respective parts of the edge restoration unit 230 of FIG. 2. The image enlargement unit 236 is the same as the image enlargement unit 223 of the reduction NR unit 220, and enlarges the reduced image N times to convert the reduced image to an image of original size.

The image reduction unit 221 shown in FIG. 2 as the configuration of the reduction NR unit 220 is shown outside a broken-line frame representing the configuration of a reduction NR unit 620 in the NR unit 600. A reduced image which is generated from the high-frequency noise-removed image by the image reduction unit 221 is supplied to an image enlargement unit 236 of an edge restoration unit 630 and a low-frequency noise removal unit 222 of the reduction NR unit 620.

As shown in FIG. 10, the unsharp mask processing is performed before the reduction NR processing, whereby it is possible to enhance the contrast of the entire image. The unsharp mask processing is performed after high-frequency noise is removed, whereby it is possible to prevent high-frequency noise from being determined to be an edge and enhanced in the unsharp mask processing.

### [Operation Example of NR Unit]

Next, the operation of the NR unit 600 according to the second embodiment of the present technology will be described referring to the drawings.

FIG. 11 is a flowchart showing a processing procedure when image processing is performed by the NR unit 600 according to the second embodiment of the present technology.

First, it is determined whether or not to start image processing (Step S931), and when it is determined not to start the image processing, it waits for starting the image processing.

When it is determined to start image processing (Step S931), an image (high-frequency noise-removed image) with high-frequency noise removed is generated by the high-frequency noise removal unit 210 (Step S932).

Next, an image (reduced image) which is obtained by reducing (×1/N) the high-frequency noise-removed image is generated by the image reduction unit 221 (Step S933). Subsequently, an image (enlarged image) which is obtained by enlarging (×N) the reduced image is generated by the image enlargement unit 236 (Step S934). The difference (difference image) between the high-frequency noise-removed image and the enlarged image is calculated by the subtractor 231 (Step S935).

Thereafter, a value (gain) which adjusts the difference value for addition in the unsharp mask processing is set by the gain setting unit 232 (Step S936). Subsequently, the difference value is adjusted on the basis of the set gain by the difference adjustment unit 233 (Step S937). An image (contrast-enhanced image) which is obtained by adding the adjusted difference value and the image after reduction NR is generated by the adder 234 (Step S938).

Subsequently, low-frequency noise in the reduced image is removed by the low-frequency noise removal unit 222 (Step S939). An image (low-frequency noise-removed image) which is obtained by enlarging (×N) the reduced image with low-frequency noise removed is generated by the image enlargement unit 223 (Step S940).

The addition ratio is calculated by the addition determination unit 224 (Step S941). Thereafter, an image (output image) which is obtained by blending the contrast-enhanced image and the low-frequency noise-removed image on the basis of the addition ratio is generated by the added image generation unit 225 (Step S942), and the processing procedure of the image processing by the NR unit 200 ends.

In this way, according to the second embodiment of the present technology, it is possible to enhance the contrast of the entire image in the unsharp mask processing and to remove low-frequency noise. That is, according to the second embodiment of the present technology, it is possible to improve image quality in an image subjected to noise removal processing.

Although in FIG. 10, an example where the reduction ratio is the same has been described, when enhancing the contrast of the entire image, since it is not necessary to share the result of edge determination, a case where the reduction ratio is set separately is considered. However, as shown in FIG. 10, the reduced image generated by the image reduction unit 221 is shared, whereby it is possible to reduce circuit scale.

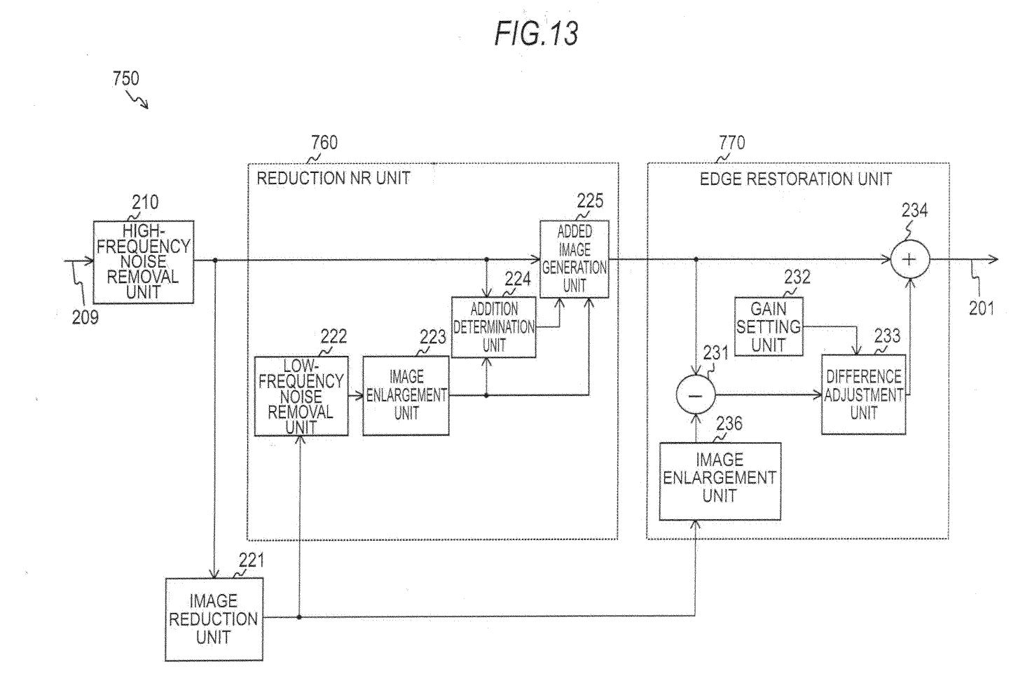

As shown in FIG. 10, when the reduced image generated by the image reduction unit 221 is shared in both kinds of processing, enhancement of the edge and the near edge and contrast enhancement of the entire image can be performed by a single NR unit. That is, the sequence of the reduction NR unit 600 and the edge restoration unit 630 in the NR unit 600 of FIG. 10 are reversed. When the sequence is reversed, the same applies to that described in FIG. 13 as a modification, thus description herein will not be repeated. Accordingly, as in FIG. 2, the high-frequency noise-removed image is supplied to the reduction NR unit, and the image after reduction NR is supplied to the edge restoration unit, whereby as in the first embodiment of the present technology, it is possible to enhance only the near edge and the edge. In this way, the reduced image generated by the image reduction unit 221 is used to perform the reduction NR processing and the unsharp mask processing, whereby it is possible to switch and perform contrast enhancement of the entire image and enhancement of only the edge and the near edge by a single NR unit, and to reduce circuit scale.

### 3. Modification

As described in the first and second embodiments of the present technology, if band limitation in the reduction NR processing and the unsharp mask processing is the same, it is possible to enhance only the edge and the near edge. As a method which makes the band limitation the same, a method other than those described in the first and second embodiments of the present technology may be considered.

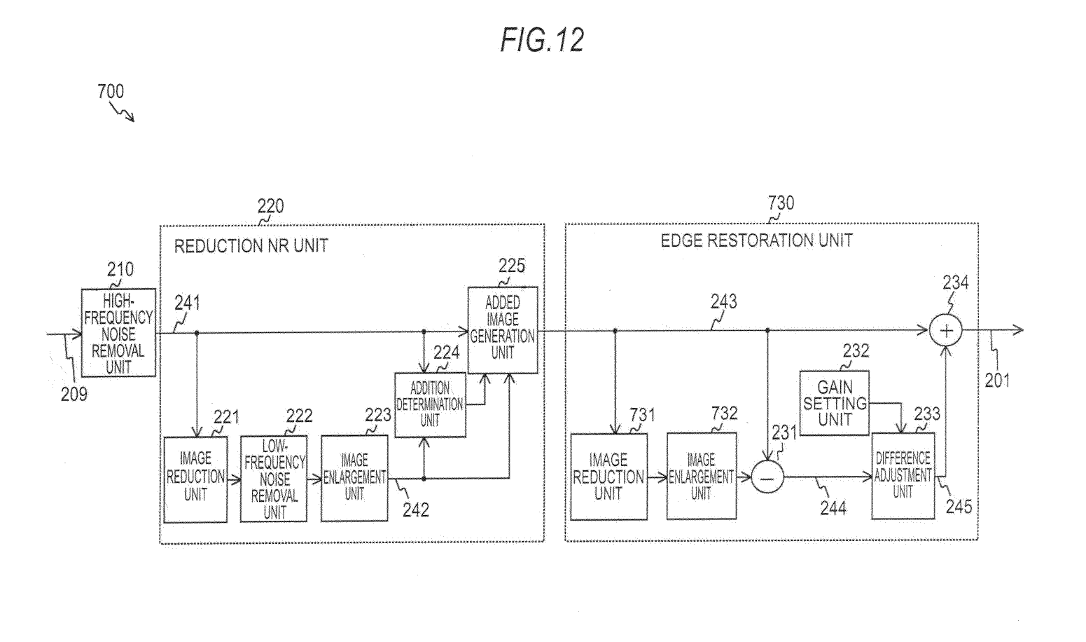

Accordingly, in FIG. 12, as a modification of the first embodiment of the present technology, an example where the difference is calculated using an image obtained by reducing the image after reduction NR will be described. In FIG. 13, as a modification of the first embodiment of the present technology, an example where the edge and the near edge are enhanced using the reduced image generated by the image reduction unit 221 will be described.

FIG. 12 is a block diagram showing an example of the functional configuration of an NR unit (NR unit 700), which calculates the difference using an image obtained by reducing the image after reduction NR, as a modification of the first embodiment of the present technology.

The NR unit 700 is a modification of the NR unit 200 shown in FIG. 2, and has a difference in that a configuration for reducing and enlarging the image after reduction NR is provided in the edge restoration unit 730. Accordingly, the same parts as those of the NR unit 200 of FIG. 2 are represented by the same reference numerals, and description herein will not be repeated.

The edge restoration unit 730 includes an image reduction unit 731 which reduces the image after reduction NR 1/N times, and an image enlargement unit 732 which enlarges the reduced image after reduction NR N times, in addition to the configuration of the edge restoration unit 230 of the FIG. 2. An image enlarged by the image enlargement unit 732 is supplied to the subtractor 231, and the difference value is calculated between this image and the image after reduction NR.

As shown in FIG. 12, even when calculating the difference value by reducing the image after reduction NR, the same reduction ratio as in the reduction NR processing is used, whereby it is possible to appropriately enhance the edge and the near edge, and to restore resolution at these positions.

FIG. 13 is a block diagram showing an example of the functional configuration of an NR unit (NR unit 750), in which the reduction NR processing and enhancement of the near edge are performed using the reduced image generated by the image reduction unit 221, as a modification of the first embodiment of the present technology.

The NR unit 750 is a modification of the NR unit 200 shown in FIG. 2, and an edge restoration unit 770 includes an image enlargement unit 236 which enlarges the reduced image supplied from the image reduction unit 221, in addition to the respective parts of the edge restoration unit 230 of FIG. 2. The image reduction unit 221 is shown outside a broken-line frame representing the configuration of the reduction NR unit 760. That is, the sequence of the reduction NR processing and the unsharp mask processing is reversed compared to the NR unit 600 according to the second embodiment of the present technology.

In the NR unit 750, since the reduced image with the same reduction ratio is used to perform the unsharp mask processing after the reduction NR processing, as in the first embodiment of the present technology, it is possible to appropriately enhance the edge and the near edge.

In addition to the modifications shown in FIGS. 12 and 13, various modifications are considered. For example, when resolution deterioration at the near edge in an image, in which the contrast of the entire image is enhanced by the NR unit 600 shown in FIG. 10, is problematic, only the edge and the near edge are further enhanced for this image. That is, for the image in which the contrast of the entire image is enhanced, the unsharp mask processing is performed using an image with the same reduction ratio as the reduction NR processing. Accordingly, for the image in which the contrast of the entire image is enhanced, it is possible to enhance only the edge and the near edge.

Although in the embodiments of the present technology, an example where processing is performed on an image subjected to YC conversion has been described, the present technology is not limited thereto, and an RGB image may be used directly and NR processing may be performed on the basis of an RGB signal. Although an example where correction processing is performed on the luminance component (Y) after YC conversion has been described, the present technology is not limited thereto, and NR processing may be performed on the basis of the color difference signal (Cr, Cb).

As described above, according to the embodiments of the present technology, the reduced images which are used in the reduction NR processing and the unsharp mask processing have the same reduction ratio, whereby it is possible to improve image quality in an image subjected to noise removal processing.

The foregoing embodiments are examples for implementing the present technology, and the items of the embodiments and the inventive subject matters of the appended claims have the correspondence relationship. Similarly, the inventive subject matters of the appended claims and the items of the embodiments of the present technology to which the same names as those thereof are given have the correspondence relationship. However, the present technology is not limited to the embodiments, and may be modified in various forms of the embodiments within the scope without departing from the gist of the present technology.

The processing procedure described in the foregoing embodiments may be understood as a method having a series of procedure or may be understood as a program which causes a computer to execute a series of procedure or a recording medium which stores the program. As the recording medium, for example, a hard disk, a CD (Compact Disc), an MD (Mini Disc), a DVD (Digital Versatile Disk), a memory card, a Blu-ray Disc (Registered Trademark), or the like may be used.

The present technology may be configured as follows.

(1) An image processing apparatus including:

a noise-removed image generation unit which, on the basis of an input image and a reduced image obtained by reducing the input image at predetermined magnification, generates a noise-removed image with noise in the input image removed; and

a corrected image generation unit which generates, from the noise-removed image, a high-frequency component image primarily having a frequency component of the noise-removed image in the same band as a frequency component to be removed by band limitation in the reduction at the predetermined magnification and generates an edge-corrected image on the basis of the noise-removed image and the high-frequency component image.

(2) The image processing apparatus described in (1),

wherein the corrected image generation unit generates the high-frequency component image by subtraction processing for each pixel between a low-frequency component image primarily having a frequency component to be not removed by the band limitation and the noise-removed image.

(3) The image processing apparatus described in (2),

wherein the noise-removed image generation unit generates a second noise-removed image by enlarging an image with noise in the reduced image removed at the predetermined magnification and then generates the noise-removed image by addition processing for each pixel between the second noise-removed image and the input image in accordance with an addition ratio set for each pixel, and

the corrected image generation unit generates the high-frequency component image using the second noise-removed image as the low-frequency component image.

(4) The image processing apparatus described in (2),

wherein the corrected image generation unit generates the high-frequency component image using an image obtained by reducing and then enlarging the noise-removed image at the predetermined magnification as the low-frequency component image.

(5) The image processing apparatus described in (2),

wherein the corrected image generation unit generates the high-frequency component image using an image obtained by reducing and enlarging the reduced image at the predetermined magnification as the low-frequency component image.

(6) The image processing apparatus described in (1),

wherein the corrected image generation unit generates the edge-corrected image by unsharp mask processing on the basis of the noise-removed image and the high-frequency component image.

(7) An image processing apparatus including:

a reduced image generation unit which generates a reduced image by reducing an input image at predetermined magnification;

a noise-removed image generation unit which generates a noise-removed image with noise in the input image removed on the basis of the input image and the reduced image when edge enhancement is performed on the input image; and

a corrected image generation unit which generates a high-frequency component image on the basis of the generated reduced image and the noise-removed image when the edge enhancement is performed and generates an edge-corrected image by unsharp mask processing on the basis of the noise-removed image and the high-frequency component image.

(8) The image processing apparatus described in (7),

wherein the corrected image generation unit generates a second high-frequency component image on the basis of the reduced image and the input image when contrast enhancement is performed on the input image and generates a contrast-enhanced image by the unsharp mask processing on the basis of the input image and the second high-frequency component image, and

the noise-removed image generation unit generates an image with noise in the contrast-enhanced image removed on the basis of the reduced image and the contrast-enhanced image when the contrast enhancement is performed.

(9) An imaging apparatus including:

a lens unit which condenses subject light;

an imaging device which converts subject light to an electrical signal;

a signal processing unit which converts the electrical signal output from the imaging device to a predetermined input image;

a noise-removed image generation unit which, on the basis of the input image and a reduced image obtained by reducing the input image at predetermined magnification, generates a noise-removed image with noise in the input image removed;

a corrected image generation unit which generates, from the noise-removed image, a high-frequency component image primarily having a frequency component of the noise-removed image in the same band as a frequency component to be removed by band limitation in the reduction at the predetermined magnification and generates an edge-corrected image on the basis of the noise-removed image and the high-frequency component image; and

a recording processing unit which compresses and encodes the generated edge-corrected image to generate and record recording data.

(10) An image processing method including:

on the basis of an input image and a reduced image obtained by reducing the input image at predetermined magnification, generating a noise-removed image with noise in the input image removed; and

generating, from the noise-removed image, a high-frequency component image primarily having a frequency component of the noise-removed image in the same band as a frequency component to be removed by band limitation in the reduction at the predetermined magnification and generating an edge-corrected image on the basis of the noise-removed image and the high-frequency component image.

(11) A program which causes a computer to execute:

on the basis of an input image and a reduced image obtained by reducing the input image at predetermined magnification, generating a noise-removed image with noise in the input image removed,

generating, from the noise-removed image, a high-frequency component image primarily having a frequency component of the noise-removed image in the same band as a frequency component to be removed by band limitation in the reduction at the predetermined magnification and generating an edge-corrected image on the basis of the noise-removed image and the high-frequency component image.

The present disclosure contains subject matter related to that disclosed in Japanese Priority Patent Application JP 2012-138511 filed in the Japan Patent Office on Jun. 20, 2012, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
a noise-removed image generation unit which, on the basis of an input image and a reduced image obtained by reducing the input image at predetermined magnification, generates a noise-removed image with noise in the input image removed; and
a corrected image generation unit which generates, from the noise-removed image, a high-frequency component image primarily having a frequency component of the noise-removed image in the same band as a frequency component to be removed by band limitation in the reduction at the predetermined magnification and generates an edge-corrected image on the basis of the noise-removed image and the high-frequency component image.

2. The image processing apparatus according to claim 1,
wherein the corrected image generation unit generates the high-frequency component image by subtraction processing for each pixel between a low-frequency component image primarily having a frequency component to be not removed by the band limitation and the noise-removed image.

3. The image processing apparatus according to claim 2,
wherein the noise-removed image generation unit generates a second noise-removed image by enlarging an image with noise in the reduced image removed at the predetermined magnification and then generates the noise-removed image by addition processing for each pixel between the second noise-removed image and the input image in accordance with an addition ratio set for each pixel, and
the corrected image generation unit generates the high-frequency component image using the second noise-removed image as the low-frequency component image.

4. The image processing apparatus according to claim 2,
wherein the corrected image generation unit generates the high-frequency component image using an image obtained by reducing and then enlarging the noise-removed image at the predetermined magnification as the low-frequency component image.

5. The image processing apparatus according to claim 2,
wherein the corrected image generation unit generates the high-frequency component image using an image obtained by reducing and enlarging the reduced image at the predetermined magnification as the low-frequency component image.

6. The image processing apparatus according to claim 1,
wherein the corrected image generation unit generates the edge-corrected image by unsharp mask processing on the basis of the noise-removed image and the high-frequency component image.

7. An image processing apparatus comprising:
a reduced image generation unit which generates a reduced image by reducing an input image at predetermined magnification;
a noise-removed image generation unit which generates a noise-removed image with noise in the input image removed on the basis of the input image and the reduced image when edge enhancement is performed on the input image; and
a corrected image generation unit which generates a high-frequency component image on the basis of the generated reduced image and the noise-removed image when the edge enhancement is performed and generates an edge-corrected image by unsharp mask processing on the basis of the noise-removed image and the high-frequency component image.

8. The image processing apparatus according to claim 7,
wherein the corrected image generation unit generates a second high-frequency component image on the basis of the reduced image and the input image when contrast enhancement is performed on the input image and generates a contrast-enhanced image by the unsharp mask processing on the basis of the input image and the second high-frequency component image, and
the noise-removed image generation unit generates an image with noise in the contrast-enhanced image removed on the basis of the reduced image and the contrast-enhanced image when the contrast enhancement is performed.

9. An imaging apparatus comprising:
a lens unit which condenses subject light;
an imaging device which converts subject light to an electrical signal;
a signal processing unit which converts the electrical signal output from the imaging device to a predetermined input image;
a noise-removed image generation unit which, on the basis of the an input image and a reduced image obtained by reducing the input image at predetermined magnification, generates a noise-removed image with noise in the input image removed;
a corrected image generation unit which generates, from the noise-removed image, a high-frequency component image primarily having a frequency component of the noise-removed image in the same band as a frequency component to be removed by band limitation in the reduction at the predetermined magnification and generates an edge-corrected image on the basis of the noise-removed image and the high-frequency component image; and
a recording processing unit which compresses and encodes the generated edge-corrected image to generate and record recording data.

10. An image processing method comprising:
on the basis of an input image and a reduced image obtained by reducing the input image at predetermined magnification, generating a noise-removed image with noise in the input image removed; and
generating, from the noise-removed image, a high-frequency component image primarily having a frequency component of the noise-removed image in the same band as a frequency component to be removed by band limitation in the reduction at the predetermined magnification and generating an edge-corrected image on the basis of the noise-removed image and the high-frequency component image.

11. A program which causes a computer to execute:
on the basis of an input image and a reduced image obtained by reducing the input image at predetermined magnification, generating a noise-removed image with noise in the input image removed; and
generating, from the noise-removed image, a high-frequency component image primarily having a frequency component of the noise-removed image in the same band as a frequency component to be removed by band limitation in the reduction at the predetermined magnification and generating an edge-corrected image on the basis of the noise-removed image and the high-frequency component image.
